(19) United States
(12) Patent Application Publication
(10) Pub. No.: US 2026/0209627 A1
(43) Pub. Date: Jul. 23, 2026

(54) CONTINUOUS PROCESS FOR REDUCING THE MOLECULAR WEIGHT OF ETHYLENE COPOLYMERS AND TERPOLYMERS

(71) Applicant: VERSALIS S.P.A., San Donato Milanese (MI) (IT)

(72) Inventors: Maria Francesca PIRINI, Ravenna (RA) (IT); Andrea MAZZINI, Ferrara (FE) (IT); Costantino PERRETTA, Ferrara (FE) (IT)

(21) Appl. No.: 19/140,786

(22) PCT Filed: Dec. 14, 2023
(86) PCT No.: PCT/IB2023/062660

§ 371 Date: Jun. 18, 2025

(30) Foreign Application Priority Data
Dec. 19, 2022 (IT) 102022000025962

(51) Int. Cl. C10M 143/04; B29B 9/06; B29K 23/00; C08F 210/16

(52) U.S. Cl. CPC C10M 143/04; B29B 9/065; C08F 210/16; B29K 2023/16; C10M 2205/024

(57) ABSTRACT

A continuous process for reducing the molecular weight of ethylene copolymers and terpolymers [EP(D)M)] including:
(a) providing a single screw extruder having a chamber, a reciprocating single screw mounted therein and capable of rotating and oscillating therein, the chamber having feeding and discharging openings, the extruder having three conveying and mixing zones, a gear pump, an underwater die-face cutter;
(b) feeding an EP(D)M into the extruder;
(c) conveying the EP(D)M through a first zone operating at a temperature between 140° C.-260° C.;
(d) conveying the at uniformly softened EP(D)M leaving the first zone to a second operating at a temperature between 220° C.-330° C.;
(e) conveying the partially degraded EP(D)M leaving the second zone to a third operating at a temperature between 170° C.-340° C.;
(f) conveying the further degraded EP(D)M leaving the third zone to the gear pump operating at a temperature between 170° C.-340° C.;
(g) recovering the further degraded EP(D)M leaving the underwater die-face cutter.

### CROSS-REFERENCE TO RELATED APPLICATIONS

This application is a 35 U.S.C. § 371 National Stage patent application of PCT/IB2023/062660, filed on 14 Dec. 2023, which claims the benefit of Italian patent application no. 102022000025962, filed on 19 Dec. 2022, the disclosures of which are incorporated herein by reference in their entirety.

### TECHNICAL FIELD

The present disclosure relates to a continuous process for reducing the molecular weight of ethylene copolymers and terpolymers [EP(D)M)].

More specifically, the present disclosure relates to a continuous process for the reduction of the molecular weight of ethylene copolymers and terpolymers [EP(D)M] comprising the use of a single screw extruder equipped with a piston screw (“reciprocating single screw”), three conveying and mixing zones, a gear pump, an underwater die-face cutter, said three conveying and mixing zones and said gear pump operating at specific temperature ranges.

The ethylene copolymers and terpolymers [EP(D)M] obtained by the above process are advantageously usable as viscosity index improvers (V.I.I.) of lubricating oils.

### BACKGROUND

Ethylene copolymers and terpolymers [EP(D)M)] are widely used in the field of lubricating oil additives [also known in the industry as Olefin CoPolymers (OCP)] as viscosity index improvers (V.I.I.) in order to modulate the viscosity of said lubricating oils with changing temperatures.

The micro/macrostructure of the ethylene copolymers and terpolymers [EP(D)M)], the weight-average molecular weight (M_{w}), the polydispersity index (PDI), i.e., the ratio between the weight-average molecular weight (M_{w}) and the number-average molecular weight (Mₙ) (M_{w}/Mₙ) of ethylene copolymers and terpolymers [EP(D)M)], as well as the amount of said ethylene copolymers and terpolymers [EP(D)M)] used, are all factors modifying the effect of said ethylene copolymers and terpolymers as viscosity index improvers (V.I.I.) of lubricating oils and the final properties of the formulations in which they are used.

Optimisation of the micro/macrostructure of ethylene copolymers and terpolymers [EP(D)M] allows the right compromise to be found in order to achieve the desired technological parameters.

Furthermore, since low molecular weights are essential for the application performance of viscosity index improvers (V.I.I.) of lubricating oils, and the processes usually used for the production of ethylene copolymers and terpolymers [EP(D)M)] (solution or slurry processes) often provide ethylene copolymers and terpolymers [EP(D)M] with significantly higher molecular weights, it is necessary to subject these ethylene copolymers and terpolymers [EP(D)M] to thermodegradation processes.

For example, European patent EP 1013673 relates to a process for reducing the molecular weight of a polymeric material selected from ethylene copolymers and terpolymers [EP(D)M)] or mixtures thereof, comprising treating the polymeric material with at least one hydroperoxide, said hydroperoxide being present in sufficient quantity to cause a reduction in molecular weight, at a temperature comprised between 80° C. and 250° C., said ethylene copolymers and terpolymers [EP(D)M)] having a molar propylene content comprised between 16% and 50%. The resulting ethylene copolymers and terpolymers [EP(D)M] are said to have several applications, including use as viscosity index improvers (V.I.I.) of lubricating oils and the modification of high-fluidity plastics. The above process can be carried out in an extruder, preferably a twin-screw extruder.

European patent EP 1671982 relates to a process for the preparation of viscosity index improvers (V.I.I.) having improved dimensional stability and capable of improving the rheology of low-temperature lubricating oils, said process comprising the treatment of mixtures of linear polyethylene which is an ethylene homopolymer or copolymer characterised by a crystalline structure and a density comprised between 0.88 and 0.94 and amorphous ethylene copolymers and terpolymers [EP(D)M)], optionally blended with semi-crystalline ethylene copolymers and terpolymers [EP(D)M)], said treatment being carried out in an extruder, said treatment being carried out in the presence of one or more substances of a hydroperoxide nature and, optionally, in the presence of polyfunctional vinyl monomers in an amount comprised between 0% by weight and 2% by weight, said treatment being carried out at a shear value greater than 100 sec⁻¹ and at a temperature comprised between 75° C. and 260° C., said amorphous ethylene copolymers and terpolymers [EP(D)M)] being characterised by an ethylene content comprised between 35% by weight and 62% by weight and a content of the third monomer comprised between 0% by weight and 10% by weight. The above process can be carried out in an extruder, preferably a twin-screw extruder.

European Patent EP 1632504 relates to a process for the preparation of viscosity index improvers (V.I.I.) involving treating, under high shear conditions, a composition comprising: (i) one or more ethylene copolymer(s) or terpolymer(s) [EP(D)M)] and (ii) one or more polyvinylarylene/hydrogenated conjugated diene/polyvinylarylene block copolymers, the ratio by weight (i)/(ii) being comprised between 98/2 and 80/20, said process being carried out at a temperature comprised between 150° C. and 400° C., for a time not exceeding 150 seconds and at a shear value greater than 75 sec⁻¹. The above process can be carried out in an extruder, preferably a twin-screw extruder.

European Patent EP 1984479 relates to a process for the preparation of viscosity index improvers (V.I.I.) of lubricating oils comprising a mixing treatment under shear conditions greater than 50 sec⁻¹, of a composition comprising:
(i) one or more ethylene copolymers or terpolymers [EP(D)M)];
(ii) one or more polyvinylarylene/hydrogenated conjugated diene/polyvinylarylene block copolymers;
(iii) lubricating oil;
(ii) being present at a concentration comprised between 1.5% by weight and 20% by weight and (iii) being present at a concentration comprised between 1.5% by weight and 45% by weight.

The above process can be carried out in an extruder, preferably a twin-screw extruder.

Canadian Patent CA 991792 relates to a continuous process for producing a lubricating oil additive by thermal degradation in an extruder, under non-oxidising conditions, of a substantially linear, high molecular weight, amorphous ethylene-propylene hydrocarbon copolymer containing 25%-50% by weight of polymerised propylene, 0%-5% by weight of a polymerised non-conjugated hydrocarbon diene and the remainder, polymerised ethylene, said process comprising: uniformly mixing and heating the copolymer in an initial zone at a temperature comprised between about 150° C. and 280° C. until the copolymer is uniformly melted, said temperature being below the degradation temperature of the copolymer; passing the molten copolymer into a second zone where it is uniformly mixed and heated to a temperature comprised between about 300° C. and 500° C., until a degraded copolymer is obtained whose inherent viscosity is lower than the inherent viscosity of the starting copolymer and is comprised between 0.1 dl/g and 1.8 dl/g, measured on a solution of 0.1 g of copolymer in 100 ml of tetrachloroethylene at 30° C., and whose molecular weight distribution is substantially less than or equal to that of the starting copolymer; removing the degraded copolymer from the second zone; cooling and recovering the degraded copolymer that is substantially colourless or white and contains an insubstantial amount of oil insoluble material.

However, the above processes may have some drawbacks. For example, in order to obtain ethylene copolymers and terpolymers [EP(D)M)] with molecular weights suitable for use as viscosity index improvers (V.I.I.), it may be necessary to use hydroperoxides, or to operate at high temperatures (up to 500° C.), which require operating in an inert atmosphere (for example, in the presence of nitrogen) and which may lead to gel formation and branching in the final product. Furthermore, in order to improve the dimensional stability of the ethylene copolymers and terpolymers [EP(D)M)] obtained, it may be necessary to use small amounts of polyvinylarylene/hydrogenated conjugated diene/polyvinylarylene block copolymers or polyfunctional vinyl monomers.

### SUMMARY

The Applicant therefore set out to solve the problem of finding a continuous process for the reduction of the molecular weight of ethylene copolymers and terpolymers [EP(D)M] that could advantageously be used as viscosity index improvers (V.I.I.) of lubricating oils, able to overcome the above-mentioned drawbacks.

The Applicant has now come up with a continuous process for reducing the molecular weight of ethylene copolymers and terpolymers [EP(D)M] comprising the use of a single screw extruder equipped with a reciprocating single screw, three conveying and mixing zones, a gear pump, an underwater die-face cutter, said three conveying and mixing zones and said gear pump operating at specific temperature ranges. In particular, the Applicant has found that the use of said single screw extruder allows to obtain ethylene copolymers and terpolymers [EP(D)M)] having molecular weights suitable for use as viscosity index improvers (V.I.I.) in the absence of hydroperoxides, operating at lower temperatures than in the prior art so as to avoid both operating in an inert atmosphere and the formation of gels and branching in the final product. Furthermore, said process does not require the use of polyvinylarylene/hydrogenated conjugated diene/polyvinylarylene block copolymers or polyfunctional vinyl monomers in order to improve the dimensional stability of the final product.

The present disclosure therefore provides a continuous process for reducing the molecular weight of ethylene copolymers and terpolymers [EP(D)M)] comprising the following stages:
(a) providing at least one single screw extruder comprising a chamber, a reciprocating single screw mounted in said chamber, said reciprocating single screw being capable of rotating and oscillating within said chamber, said chamber having at least one feeding opening and at least one discharging opening, said extruder comprising three conveying and mixing zones, a gear pump, an underwater die-face cutter;
(b) feeding at least one ethylene copolymer or terpolymer [EP(D)M)] into said single screw extruder;
(c) conveying said at least one ethylene copolymer or terpolymer [EP(D)M)] through a first conveying and mixing zone which operates at a temperature comprised between 140° C. and 260° C., preferably comprised between 150° C. and 250° C., wherein said ethylene copolymer or terpolymer [EP(D)M)] is uniformly mixed and heated and uniformly softened;
(d) conveying said at least one uniformly softened ethylene copolymer or terpolymer [EP(D)M)] leaving said first conveying and mixing zone to a second conveying and mixing zone which operates at a temperature comprised between 220° C. and 330° C., preferably comprised between 230° C. and 320° C., wherein said ethylene copolymer or terpolymer [EP(D)M)] is further mixed and heated and partially degraded;
(e) conveying said at least one partially degraded ethylene copolymer or terpolymer [EP(D)M)] leaving said second conveying and mixing zone to a third conveying and mixing zone which operates at a temperature comprised between 170° C. and 340° C., preferably comprised between 180° C. and 330° C., wherein said ethylene copolymer or terpolymer [EP(D)M)] is further mixed and heated and further degraded;
(f) conveying said at least one further degraded ethylene copolymer or terpolymer [EP(D)M)] leaving said third conveying and mixing zone to said gear pump which operates at a temperature comprised between 170° C. and 340° C., preferably comprised between 180° C. and 330° C., wherein said ethylene copolymer or terpolymer [EP(D)M)] is further degraded;
(g) recovering said at least one further degraded ethylene copolymer or terpolymer [EP(D)M)] leaving said underwater die-face cutter.

For the purpose of the present description and the following claims, the definitions of the numerical ranges always comprise the extreme values unless otherwise specified.

For the purpose of the present description and the following claims, the term “comprising” also includes the terms “which essentially consists of” or “which consists of”.

For the purpose of the present disclosure, a single-screw extruder equipped with a reciprocating single screw, three conveying and mixing zones, a gear pump, and an underwater die-face cutter, which also has the following features, can be used:
with respect to a conventional single-screw extruder in which the screw is in the form of a continuous spiral, the reciprocating single screw has threads interrupted at radial intervals of 1200 and pins or teeth coordinated with these threads are inserted in the barrel;
compared to a conventional single-screw extruder in which the screw movement consists solely of rotation, the movement of the reciprocating single screw consists of rotation and oscillation, in fact the rotation of the reciprocating single screw is superimposed by an oscillation (or axial stroke) that results in improved mixing and degradation capability within the extruder;
the oscillation frequency of the axial motion (“reciprocating action”) is the same as the rotational speed and a gear system ensures that for each rotation of the reciprocating single screw a full forward and backward stroke is performed;
the amplitude of oscillation is approximately 20 mm;
during the performance of the above-mentioned full forward and backward stroke, the paths traced by said pins (or teeth) cover and clean the entire surface of the reciprocating single screw so as to avoid the presence of areas with stagnation of material, in practice said threads (“kneading flights”) sway around said pins (or teeth) and this allows a very uniform speed gradient between said threads (“kneading flights”) and said pins;
the combination of the rotary and axial movement of the reciprocating single screw produces an extensional flow with a strong dispersive mixing action between threads (“kneading flights”) and pins;
the fusion of the ethylene copolymer or terpolymer [EP(D)M] takes place in the gap between the threads (“kneading flights”) and the pin;
due to the aforementioned improved mixing capacity, the ethylene copolymer or terpolymer [EP(D)M)] does not exhibit inhomogeneity in terms of solid and molten parts, rather said ethylene copolymer or terpolymer [EP(D)M)] melts at the same time, resulting in high viscosities, particularly in the first two mixing zones, which generate high shear stress values.

More details on the aforementioned single-screw extruder can be found, for example, in Elemans P. H. M. and Mejer H. E. H, “Polymer Engineering and Science” (1990), Mid-August, Vol. 30, No. 15, pp. 893-904.

In accordance with a preferred embodiment of the present disclosure, said single-screw extruder operates at a screw speed comprised between 220 rpm and 300 rpm, preferably comprised between 230 rpm and 280 rpm.

In accordance with a preferred embodiment of the present disclosure, said single-screw extruder operates at a flow rate comprised between 300 kg/h and 700 kg/h, preferably comprised between 400 kg/h and 600 kg/h.

Upon exiting said underwater die-face cutter, the degraded ethylene copolymer or terpolymer [EP(D)M] is in the form of “pellets” that are separated from the water, for example by centrifugation, and subsequently sent by pneumatic conveying to the drying and packaging section.

In accordance with a preferred embodiment of the present disclosure, said ethylene copolymer or terpolymer [EP(D)M] comprises:
from 20% by weight to 90% by weight, preferably from 40% by weight to 85% by weight, with respect to the total weight of said ethylene copolymer or terpolymer [EP(D)M)] of ethylene;
from 10% by weight to 80% by weight, preferably from 15% by weight to 60% by weight, with respect to the total weight of said ethylene copolymer or terpolymer [EP(D)M)] of propylene;
from 0% by weight to 12% by weight, preferably from 0% by weight to 5% by weight, with respect to the total weight of said ethylene copolymer or terpolymer [EP(D)M)] of a non-conjugated diene.

In accordance with a preferred embodiment of the present disclosure, said ethylene copolymer or terpolymer [EP(D)M] has the following features:
weight average molecular weight (M_{w}) comprised between 115000 Da and 500000 Da, preferably comprised between 120,000 Da to 450,000 Da, more preferably comprised between 125000 Da and 250000 Da;
a polydispersion index (PDI), i.e. the ratio between the weight average molecular weight (M_{w}) and the number average molecular weight (Mₙ) (M_{w}/Mₙ), lower than 5, preferably comprised between 1.8 and 4.5, more preferably comprised between 1.9 and 3.5.

In accordance with a preferred embodiment of the present disclosure, the optionally present non-conjugated diene may be selected, for example, from:
non-conjugated linear chain dienes such as, for example, 1,4-hexadiene, 1,6-octadiene;
non-conjugated branched chain acyclic dienes such as, for example, 5-methyl-1,4-hexadiene, 3,7-dimethyl-1,6-octadiene, 3,7-dimethyl-1,7-octadiene;
non-conjugated single ring alicyclic dienes such as, for example, 1,4-cyclohexadiene, 1,5-cyclooctadiene, 1,5-cyclododecadiene;
non-conjugated dienes having condensed or bridged alicyclic rings such as, for example, methyltetrahydroindene, dicyclopentadiene, bicyclo[2.2.1]hepta-2,5-diene, C₁-C₈-alkenyl-norbornenes, C₂-C₈-alkylidene-norbornenes, C₃-C₁₂-cyclo-alkenyl-norbornenes, C₃-C₁₂-cycloalkylidene-norbornenes such as, for example 5-methylene-2-norbornene, 5-ethylidene-2-norbornene (ENB), 5-propenyl-2-norbornene;
preferably, said non-conjugated diene is 5-ethylidene-2-norbornene (ENB).

Both amorphous and semi-crystalline ethylene copolymers or terpolymers [EP(D)M], alone or in a mixture with each other, can be advantageously used for the purpose of the process of the present disclosure.

Ethylene copolymers and terpolymers [EP(D)M] that can be advantageously used for the purpose of the present disclosure and that are currently commercially available are Dutral® CO products by Versalis.

The ethylene copolymers and terpolymers [EP(D)M)] obtained by the above process have the following features:
weight average molecular weight (M_{w}) comprised between 50000 Da and 140000 Da, preferably comprised between 75000 Da and 120000 Da;
a polydispersity index (PDI), i.e. the ratio between the weight-average molecular weight (M_{w}) and the number-average molecular weight (Mₙ) (M_{w}/Mₙ), lower than 5, preferably comprised between 1.8 and 4.5, more preferably comprised between 1.9 and 3.5;
a thickening power (TP) comprised between 4 cSt and 7 cSt;
a shear stability index (SSI) comprised between 20% and 30%.

The aforementioned ethylene copolymers and terpolymers [EP(D)M] are advantageously usable as viscosity index improvers (V.I.I.) of lubricating oils.

Preferably, the aforementioned ethylene copolymers and terpolymers [EP(D)M)] can be used in lubricating oils selected from mineral base oils or from synthetic base oils.

Accordingly, the present disclosure provides the use of the ethylene copolymers and terpolymers obtained by the process according to the present disclosure, as viscosity index improvers (V.I.I.) of lubricating oils, said lubricating oils being preferably selected from mineral base oils, or from synthetic base oils.

### BRIEF DESCRIPTION OF THE DRAWINGS

FIG. 1 below shows an embodiment of the process of the present disclosure as well as a block diagram of the plant and the single-screw extruder used in said process, for illustrative and non-limiting purposes only.

### DETAILED DESCRIPTION OF THE DRAWINGS

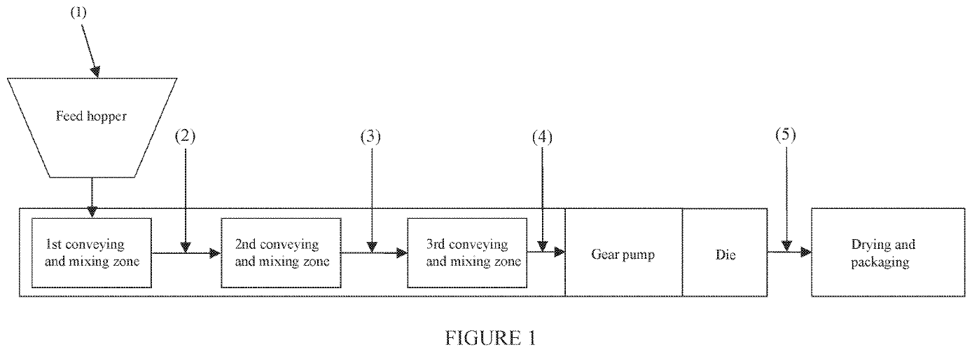

Specifically, in FIG. 1, the ethylene copolymer or terpolymer [EP(D)M)] (1) is fed through the feed hopper to the single-screw extruder equipped with three conveying and mixing zones, a gear pump and an underwater die-face cutter, said three conveying and mixing zones and said gear pump operating at specific temperature ranges. In particular, the ethylene copolymer or terpolymer [EP(D)M)] (1) through the first conveying and mixing zone is uniformly mixed and heated and uniformly softened obtaining the ethylene copolymer or terpolymer [EP(D)M)] (2) which is conveyed to the second conveying and mixing zone where it is further mixed and heated and partially degraded, resulting in the partially degraded ethylene copolymer or terpolymer [EP(D)M)] (3) which is conveyed to the third conveying and mixing zone where it is further mixed and heated and further degraded obtaining further degraded ethylene copolymer or terpolymer [EP(D)M] (4) which is conveyed to the gear pump obtaining further degraded ethylene copolymer or terpolymer [EP(D)M] (5) which is recovered at the exit from the underwater die-face cutter in the form of “pellets” which are separated from the water, for example by centrifugation, and subsequently sent by pneumatic conveying to the drying and packaging section.

In order to better understand the present disclosure and to put it into practice, some illustrative and non-limiting examples thereof are reported below.

The analysis and characterization methods reported below were used.

¹³C-NMR and ¹H-NMR Spectra

The ¹³C-NMR and ¹H-NMR spectra were recorded at 120° C. by nuclear magnetic resonance spectrometer mod. Bruker Avance 300, equipped with 10 mm probe and variable temperature.

For this purpose, polymer solutions of the degraded ethylene copolymers and terpolymers [EP(D)M)] obtained by the process of the present disclosure were used, having concentrations of 10%-15% w/v (g/mL) prepared using deuterated tetrachloroethane (C₂D₂Cl₄) at 120° C. and tetramethylsilane (TMS) as an internal standard.

The structure of the degraded ethylene copolymers and terpolymers [EP(D)M)] obtained by the process of the present disclosure [i.e., content of ethylene (%), propylene (%) and optionally non-conjugated diene] was determined by analysis of the above spectra on the basis of what has been reported in the literature by Di Martino S., Kelchterrmans M., in “Journal of Applied Polymer Science” (1995), Vol. 56, Issue 13, p. 1781-1787 (Method No. 3, page 1784).

### Determination of the Molecular Weight

The determination of the weight average molecular weight (M_{w}), the number average molecular weight (Mₙ) and the polydispersity index (PDI) corresponding to the ratio M_{w}/Mₙ, of the degraded ethylene copolymers and terpolymers [EP(D)M)] obtained by the process of the present disclosure was carried out by means of GPC (“Gel Permeation Chromatography”), using the integrated instrument HT-GPC PL220 by Agilent Technologies which uses three lines of detection refractive index (“IR”), viscometer (“VS”) and dual angle laser light scattering (“DALLS”), operating under the following conditions:
a pre-column (Guard column) with dimensions 50×7.5 mm and a particle size of 10 m;
three GPC columns by Agilent Technologies with dimensions 300×7.5 mm, particle size of 10 m with mixed porosity;
Mettler XPR 225 analytical balance;
laboratory glassware;
distillation and degassing system for solvent recovery;
50 ml automatic distributors;
pL-SP-260 automatic dissolver by Agilent Technologies;
column injection temperature: 135° C.;
temperature of columns and detection lines: 135° C.;
solvent/eluent: 1,2-dichlorobenzene (99+% for HPLC—Acros Organics™);
flow rate: 1 ml/min;
calculation of molecular mass via universal calibration curve.

These operating conditions were continuously monitored using a personal computer equipped with Agilent GPC/SEC software by Agilent Technologies.

Calibration was carried out as follows.

A solution was prepared in 1,2-dichlorobenzene (99+% for HPLC—Acros Organics™) containing a polystyrene (PS) standard with a nominal peak molecular weight (Mₚ) of 100 kDa, in order to carry out the determination of the interdetector delay (IDD) and the calibration constants of the four signals (RID, VS, LS15° and LS90°).

Seven solutions in 1,2-dichlorobenzene (99+% for HPLC—Acros Organics™) were also prepared, each containing two monodisperse polystyrene (PS) standards with different nominal peak molecular weights (Mₚ) and at different concentrations: the molecular weights were chosen so that the eluted chromatographic peaks were well separated, while the choice of concentrations of each standard was inversely proportional to the molecular weight. The range of the different nominal peak molecular weights (Mₚ) of said standards used for the calibration curve was comprised between 2 kDa and 7000 kDa.

The different solutions were prepared, under stirring, at room temperature (25° C.) in the above-mentioned PL-SP-260 automatic dissolver by Agilent Technologies.

The calibration curve was calculated using a personal computer equipped with the aforementioned Agilent GPC/SEC software by Agilent Technologies, using a 3rd order polynomial function.

### Determination of Thickening Power (TP)

The thickening power (TP) was determined in accordance with ASTM D7042-04.

### Determination of the Shear Stability Index (SSI)

The shear stability index (SSI) was determined in accordance with ASTM D7109-12.

### Example 1 (Disclosure)

The amorphous ethylene propylene copolymer Dutral® CO 058 (Versalis) having:
54% by weight of ethylene;
46% by weight of propylene;
weight average molecular weight (M_{w}) 190000 Da;
polydispersity index (PDI) of 2.2;
   was fed to a single-screw extruder (BUSS MDK 140 by Aaron Equipment) with a reciprocating screw, equipped with three conveying and mixing zones, a gear pump and an underwater die-face cutter, with a diameter of 140 mm and a ratio between the length (L) and the diameter (D) (L/D) equal to 11, at a flow rate of 500 kg/h, said extruder operating under the following conditions:
rotation speed of the screw: 260 rpm;
temperature profile 1^{st} zone: 160° C.-210° C.;
temperature profile 2^{nd} zone: 270° C.-310° C.;
temperature profile 3^{rd} zone: 280° C.-320° C.;
gear pump temperature: 280° C.-320° C.

Upon exiting the underwater die-face cutter (cutting speed equal to 2700 rpm), the degraded and cooled copolymer was recovered in the form of “pellets” that were subjected to centrifugation to separate them from the water and then sent by pneumatic conveying to the drying and packaging section.

The degraded copolymer obtained was subjected to NMR and GPC (“Gel Permeation Chromatography”) analysis operating as described above, obtaining the following values:
54% by weight of ethylene;
46% by weight of propylene;
weight average molecular weight (M_{w}) of 80000 Da;
polydispersity index (PDI) of 2.2.

### Example 2 (Disclosure)

A mixture consisting of:
70% by weight of semi-crystalline ethylene propylene copolymer Dutral® CO 034 (Versalis) having the following features:
   68% by weight of ethylene;
   32% by weight of propylene;
   weight average molecular weight (M_{w}) 130000 Da;
   polydispersity index (PDI) of 2.2;
30% by weight of amorphous ethylene propylene copolymer Dutral® CO 058 (Versalis) having the above features;
   was fed to a single-screw extruder (BUSS MDK 140 by Aaron Equipment) with a reciprocating screw, equipped with three conveying and mixing zones, a gear pump and an underwater die-face cutter, with a diameter of 140 mm and a ratio between the length (L) and the diameter (D) (L/D) equal to 11, at a flow rate of 500 kg/h, said extruder operating under the following conditions:
rotation speed of the screw: 280 rpm;
temperature profile 1^{st} zone: 180° C.-240° C.;
temperature profile 2^{nd} zone: 250° C.-300° C.;
temperature profile 3^{rd} zone: 190° C.-300° C.
gear pump temperature: 190° C.-300° C.

Upon exiting the underwater die-face cutter (cutting speed equal to 2700 rpm), the degraded and cooled copolymer was recovered in the form of “pellets” that were subjected to centrifugation to separate them from the water and then sent by pneumatic conveying to the drying and packaging section.

The degraded copolymer obtained was subjected to NMR and GPC (“Gel Permeation Chromatography”) analysis operating as described above, obtaining the following values:
63.5% by weight of ethylene;
36.5% by weight of propylene;
weight average molecular weight (M_{w}) of 85000 Da;
polydispersity index (PDI) of 2.2.

### Example 3 (Comparative)

The amorphous ethylene propylene copolymer Dutral® CO 058 (Versalis) having:
54% by weight of ethylene;
46% by weight of propylene;
weight average molecular weight (M_{w}) 190000 Da;
polydispersity index (PDI) of 2.2;
   was fed to a single-screw extruder (Goettfert 20D by Goetffert GmBH) without a reciprocating screw, equipped with three conveying and mixing zones and a die, with a diameter equal to 2 mm and a ratio between the length (L) and the diameter (D) (L/D) equal to 20, at a flow rate of 1 kg/h, said extruder operating under the following conditions:
rotation speed of the screw: 100 rpm;
temperature profile 1^{st} zone: 160° C.-180° C.;
temperature profile 2^{nd} zone: 290° C.-310° C.;
temperature profile 3^{rd} zone: 300° C.-320° C.;
cooling in a water bath.

Upon exiting the die, the degraded and cooled copolymer was recovered in the form of “spaghetti” that were air-dried.

The copolymer obtained was subjected to NMR and GPC (“Gel Permeation Chromatography”) analysis operating as described above, obtaining the following values:
54% by weight of propylene;
46% by weight of ethylene;
weight average molecular weight (Mw) of 150000 Da;
polydispersity index (PDI) of 2.2.

### Example 4 (Comparative)

A mixture consisting of:
70% by weight of semi-crystalline ethylene propylene copolymer Dutral® CO 034 (Versalis) having the following features:
   68% by weight of ethylene;
   32% by weight of propylene;
   weight average molecular weight (M_{w}) 130000 Da;
   polydispersity index (PDI) of 2.2;
30% by weight of amorphous ethylene propylene copolymer Dutral® CO 058 (Versalis) having the above features;
   was fed to a single-screw extruder (Goettfert 20D by Goetffert GmBH) without a reciprocating screw, equipped with three conveying and mixing zones and a die, with a diameter equal to 2 mm and a ratio between to length (L) and the diameter (D) (L/D) equal to 20, at a flow rate of 1 kg/h, said extruder operating under the following conditions:
rotation speed of the screw: 100 rpm;
temperature profile 1^{st} zone: 160° C.-180° C.;
temperature profile 2^{nd} zone: 270° C.-300° C.;
temperature profile 3^{rd} zone: 290° C.-320° C.;
cooling in a water bath.

Upon exiting the die, the degraded and cooled copolymer was recovered in the form of “spaghetti” that were air-dried.

The copolymer obtained was subjected to NMR and GPC (“Gel Permeation Chromatography”) analysis operating as described above, obtaining the following values:
63.5% by weight of propylene;
36.5% by weight of ethylene;
weight average molecular weight (Mw) of 160000 Da;
polydispersity index (PDI) of 2.2.

### Example 5 (Disclosure)

### Evaluation as Viscosity Index Improvers (V.I.I.) of Lubricating Oils

For this purpose, the degraded ethylene propylene copolymers (EPR) obtained in Examples 1 (disclosure), 2 (disclosure), 3 (comparative) and 4 (comparative) were dissolved in an amount equal to 1% by weight in the reference base oil SN 150 Group I (Eni S.p.A.).

The solutions obtained were used to determine the thickening power (TP) in accordance with ASTM D7402-04 and the shear stability index (SSI) in accordance with ASTM D7109-12, as listed above: the results are shown in Table 2.

The SN 150 base oil has the following features:
kinematic viscosity (KV) 100° C. equal to 5.3 cSt;
pour point equal to −15° C.

TABLE 2

| | Thickening | Shear stability |
|---|---|---|
| | power (TP) | index (SSI) |
| | (cSt) | (%) |
| Ethylene propylene copolymer | 5.8 | 29 |
| (EPR) | | |
| Example 1 (disclosure) | | |
| (1% by weight) | | |
| Ethylene propylene copolymer | 6.9 | 26 |
| (EPR) | | |
| Example 2 (disclosure) | | |
| (1% by weight) | | |
| Ethylene propylene copolymer | 10 | 51 |
| (EPR) | | |
| Example 3 (comparative) | | |
| (1% by weight) | | |
| Ethylene propylene copolymer | 12 | 52 |
| (EPR) | | |
| Example 4 (comparative) | | |
| (1% by weight) | | |

The data in Table 2 show that the ethylene-propylene copolymers (EPR) obtained using a non-reciprocating single-screw extruder [Example 3 (comparative) and Example 4 (comparative)] do not give the desired results when used as viscosity index improvers.

1. A continuous process for reducing the molecular weight of ethylene copolymers and terpolymers [EP(D)M)], the process including the following stages:
(a) providing at least one single screw extruder comprising a chamber, a reciprocating single screw mounted in said chamber, said reciprocating single screw being capable of rotating and oscillating within said chamber, said chamber having at least one feeding opening and at least one discharging opening, said extruder comprising three conveying and mixing zones, a gear pump, an underwater die-face cutter;
(b) feeding at least one ethylene copolymer or terpolymer [EP(D)M)] into said single screw extruder;
(c) conveying said at least one ethylene copolymer or terpolymer [EP(D)M)] through a first conveying and mixing zone which operates at a temperature comprised between 140° C. and 260° C., wherein said ethylene copolymer or terpolymer [EP(D)M)] is uniformly mixed and heated and uniformly softened;
(d) conveying said at least one uniformly softened ethylene copolymer or terpolymer [EP(D)M)] leaving said first conveying and mixing zone to a second conveying and mixing zone which operates at a temperature comprised between 220° C. and 330° C., wherein said ethylene copolymer or terpolymer [EP(D)M)] is further mixed and heated and partially degraded;
(e) conveying said at least one partially degraded ethylene copolymer or terpolymer [EP(D)M)] leaving said second conveying and mixing zone to a third conveying and mixing zone which operates at a temperature comprised between 170° C. and 340° C., wherein said ethylene copolymer or terpolymer [EP(D)M)] is further mixed and heated and further degraded;
(f) conveying said at least one further degraded ethylene copolymer or terpolymer [EP(D)M)] leaving said third conveying and mixing zone to said gear pump which operates at a temperature comprised between 170° C. and 340° C.° C., wherein said ethylene copolymer or terpolymer [EP(D)M)] is further degraded; and
(g) recovering said at least one further degraded ethylene copolymer or terpolymer [EP(D)M)] leaving said underwater die-face cutter.

2. The continuous process for reducing the molecular weight of ethylene copolymers and terpolymers [EP(D)M)] according to claim 1, wherein said single screw extruder operates at a rotation speed of the screw comprised between 220 rpm and 300 rpm.

3. The continuous process for reducing the molecular weight of ethylene copolymers and terpolymers [EP(D)M)] according to claim 1, wherein said single screw extruder operates at a flow rate comprised between 300 kg/h and 700 kg/h.

4. The continuous process for reducing the molecular weight of ethylene copolymers and terpolymers [EP(D)M)] according to claim 1, wherein said ethylene copolymer or terpolymer [EP(D)M)] comprises:
from 20% by weight to 90% by weight, with respect to the total weight of said ethylene copolymer or terpolymer [EP(D)M)] of ethylene;
from 10% by weight to 80% by weight, with respect to the total weight of said ethylene copolymer or terpolymer [EP(D)M)] of propylene; and
from 0% by weight to 12% by weight, with respect to the total weight of said ethylene copolymer or terpolymer [EP(D)M)] of a non-conjugated diene.

5. The continuous process for reducing the molecular weight of ethylene copolymers and terpolymers [EP(D)M)] according to claim 1, wherein said ethylene copolymer or terpolymer [EP(D)M)] has the following features:
weight average molecular weight (Mw) comprised between 115000 Da and 500000 Da; and
a polydispersion index (PDI), i.e. the ratio between the weight average molecular weight (M_{w}) and the number average molecular weight (Mₙ) (M_{w}/Mₙ), lower than 5.

6. The continuous process for reducing the molecular weight of ethylene copolymers and terpolymers [EP(D)M)] according to claim 4, wherein the optionally present non-conjugated diene is selected from:
non-conjugated linear chain dienes such as 1,4-hexadiene, 1,6-octadiene;
non-conjugated branched chain acyclic dienes such as 5-methyl-1,4-hexadiene, 3,7-dimethyl-1,6-octadiene, 3,7-dimethyl-1,7-octadiene;
non-conjugated single ring alicyclic dienes such as 1,4-cyclohexadiene, 1,5-cyclooctadiene, 1,5-cyclododecadiene; and
non-conjugated dienes having condensed or bridged alicyclic rings such as methyltetrahydroindene, dicyclopentadiene, bicyclo[2.2.1]hepta-2,5-diene, C₁-C₈-alkenyl-norbornenes, C₂-C₈-alkylidene-norbornenes, C₃-C₁₂-cyclo-alkenyl-norbornenes, C₃-C₁₂-cycloalkylidene-norbornenes such as, for example, 5-methylene-2-norbornene, 5-ethylidene-2-norbornene (ENB), 5-propenyl-2-norbornene.

7. A method of obtaining ethylene copolymers and terpolymers [EP(D)M)] with the process according to claim 1, as viscosity index improvers (V.I.I.) of lubricating oils, said lubricating oils being selected from mineral base oils, or from synthetic base oils.
